(19) United States
(12) Patent Application Publication
(10) Pub. No.: US 2006/0191991 A1
(43) Pub. Date: Aug. 31, 2006

(54) Tag writing and reading method for semiconductor product

(76) Inventors: Randy Huang, Guansi Township (TW); Andrew Kuo, Hsinchu City (TW); Jason Chui, Jhubei City (TW); Brian CC. Hsu, Hsinchu City (TW); Tina Feng, Taipei City (TW)

Correspondence Address: J C PATENTS, INC., 4 VENTURE, SUITE 250, IRVINE, CA, 92618, US

(21) Appl. No.: 11/049,799

(22) Filed: Feb. 2, 2005

(51) Int. Cl. G06F 17/00

(52) U.S. Cl. 235/375; 700/115

(57) ABSTRACT

A tag writing and reading method suitable for a semiconductor product are provided. In the tag writing method, a code representing a tag is provided, and then the code is converted into a tag pattern that is then combined with a portion of the pattern of the pattern. Next, the pattern is combined with the tag pattern and used as the design content of the semiconductor product. In addition, a length of line segment, a number of points or interval(s) between a plurality of line segments may be adopted for representing the code of the tag. In addition, the tag code may include a patent number.

### BACKGROUND OF THE INVENTION

1. Field of the Invention

The present invention generally relates to a tag writing and reading method. More particularly, the present invention relates to a tag writing and reading method for a semiconductor product.

2. Description of Related Art

Conventionally, tag is usually adopted for tagging information of goods. In recent years, the tag is also being applied in a variety of semiconductor products information related to, for example, a pattern of an integrated circuit (IC). In general, some useful information such as product name, product version, design date, design place, or test parameter may be tagged as the design pattern of the products for the identification of the pattern.

Furthermore, along with the advance of concept of knowledge property, information on the tags of the patterns of the products should not be arbitrarily modified by anyone else other than the concerned factories, which information is adopted for identification. Therefore, the source of the design pattern may be readily distinguished. For designers, such a tag is helpful to provide an application condition of the concept of design. For manufacturers, such a tag is helpful to avoid infringement of other's intellectual property. However, in recent years, the conventional tag used as the design pattern only includes general information that may be replaced with anyone other than the concerned factories without any difficulties. Therefore, it is highly desirable that a tag serving as product identification can not be readily tampered to safe guard designers and manufacturers.

### SUMMARY OF THE INVENTION

Therefore, the present invention is directed to a tag writing method of a semiconductor product, wherein the coded tag are converted into a tag pattern and then combined with the pattern of the integrated circuit (IC) for the identification purpose.

In addition, the present invention is directed to a tag reading method of a semiconductor product, wherein the tag pattern combined with the pattern of the IC is decoded to obtain a tag with information that reflect the design information of the IC.

According to one embodiment of the present invention, a tag writing method comprises converting a tag content into a tag pattern and then combining the tag pattern with a pattern of an integrated circuit (IC). Thus, the design content of the semiconductor product comprising the tag pattern and the pattern of the IC can be provided for identification purpose.

In one embodiment of the present invention, when the tag content is converted into a tag pattern, wherein the tag pattern may be represented by a length of a line segment, a plurality of points, or an interval between line segments may be used for representing the code.

According to one embodiment of the present invention, a tag reading method comprises reading an original file representing the pattern to identify the original file and determine the content of the original file according to a predetermined principle.

In one embodiment of the present invention, the predetermined principle described above comprises, for example, determing a length of a line segment, interval(s) between a plurality of line segments, or a plurality of points for determining the corresponding information of the original file.

Accordingly, in the tag writing method of the present invention, the tag is coded and then converted into a tag pattern, and then the tag pattern is combined with the pattern of the IC. Since the tag pattern and the circuit pattern are combined, they can not easily identified and readily tampered by any unauthorized persons. In the tag reading method of the present invention, the information of the tag is read according to a predetermined principle. Compared to the conventional tagging method, the present invention provides a tag for product identification that can not be easily tampered.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a tag writing method of a semiconductor product according to one embodiment of the present invention.

FIG. 2A is a schematic view illustrating a method of transforming a tag into a line segment with a certain length according to one embodiment of the present invention.

FIG. 2B is a schematic view illustrating a method of transforming a tag into a plurality of points according to one embodiment of the present invention.

FIG. 2C is a schematic view illustrating a method of transforming a tag into at least an interval between line segments according to one embodiment of the present invention.

FIG. 3 is a flowchart of a tag reading method for identifying and determining the tag of a semiconductor product according to one embodiment of the present invention.

FIG. 4A is a schematic illustration of determining the content of the tag comprising repeated number of points according to one embodiment of the present invention.

FIG. 4B is a schematic illustration of an intersection of a line segment according to one embodiment of the present invention.

FIG. 5 is a schematic illustration of determining the content of the tag comprising the repeated number of points according to another embodiment of the present invention.

### DESCRIPTION OF EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

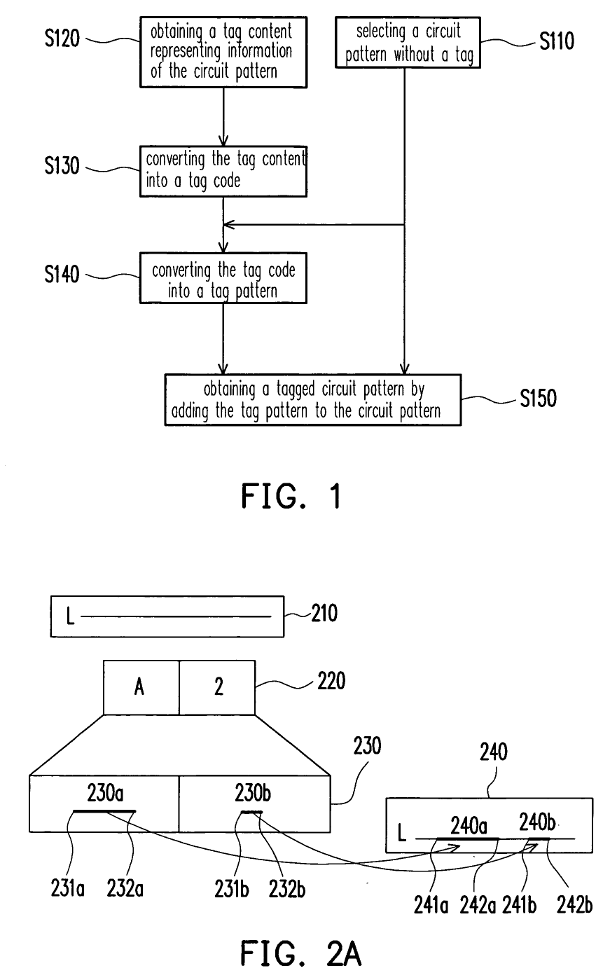

FIG. 1 is a flowchart of a tag writing method for a semiconductor product according to one embodiment of the present invention. Referring to FIG. 1, at step S110, a circuit pattern without a tag is selected. At step S120, a tag content representing information of the circuit pattern is obtained. It is noted that the term “circuit pattern” will be referred to the “circuit pattern without any tag”. Thereafter, at step S130, the tag content is converted into a tag code. Next, at step S140, the tag code is converted into a tag pattern, wherein the tag pattern is represented by, for example but not limited to, a length of a line segment, a plurality of points, or at least an interval between line segments. At step S150, the tag pattern is, for example, added to the circuit pattern to obtain a tagged circuit pattern.

In one embodiment of the present invention, the tag content may further comprises a patent number except for the original general information to facilitate management.

It should be noted that the step S130 described above, in which the tag content is being converted into a tag code is optional. In one embodiment of the present invention, when the tag comprises text that may be readily encoded (i.e., English letters or numeral including few text symbols), the text may be directly encoded skipping the step S130. Alternatively, when the tag comprises an text that may not be readily encoded (i.e., Chinese letter or teat including several text symbols), the tag may be converted into corresponding tag code via the operation of step S130 (i.e., to obtain a tag code including numeral or English letters). Subsequently, the operation of step S140 may be performed.

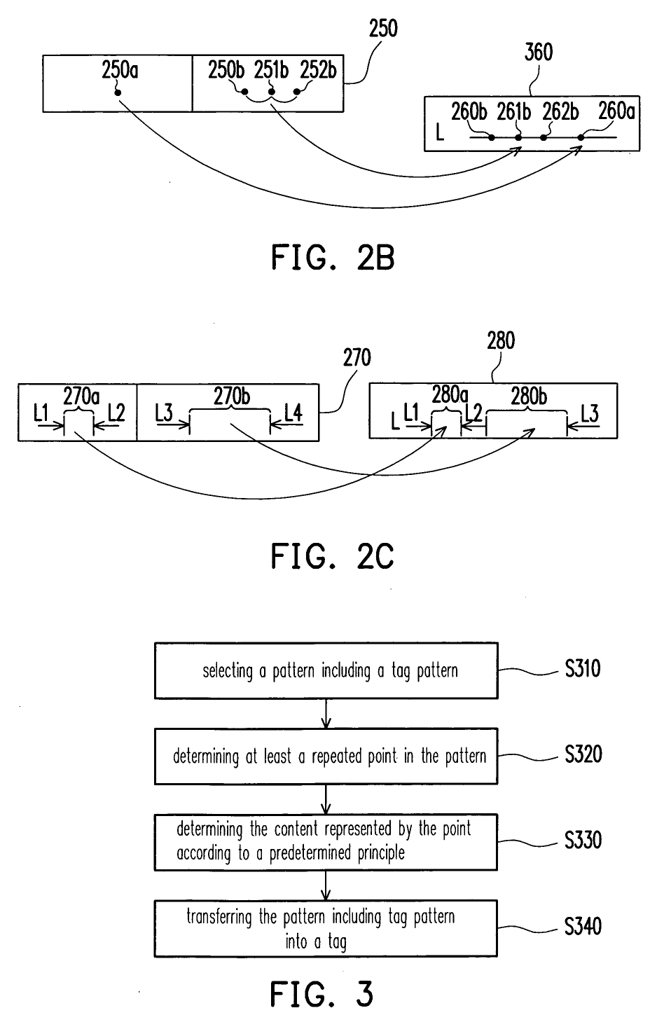

According to one embodiment of the present invention, at step S140, when the code is converted into the tag pattern, the coding method may be represented by length of a line segment. FIG. 2A is a schematic illustration of a method of converting a tag pattern represented by a length of a line segment according to one embodiment of the present invention. Referring to FIG. 2A, a pattern 210 without a tag pattern may comprise, for example, a line L, a tag 220 representing the pattern 210 may be, for example, “A2”. Next, the tag 220 content “A2” is converted into a tag code, and the length of the line segment is adopted for representing the code. The tag 220 may be converted into the tag pattern 230 via the conversion operation, wherein the tag pattern 230 is represented by a length of a line segment as shown in FIG. 2A. In one embodiment of the present invention, the content “A” of the tag 220 may be represented by a line segment 230a, and the content “2” of the tag 220 may be represented by line segment 230b.

In one embodiment of the present invention, each of the line segments 230a and 230b comprises two terminals, wherein each terminal has a coordinate point. For example, the two terminals of the line segment 230a comprise coordinate points 231a and 232a, and the two terminals of the line segment 230b comprise coordinate points 231b and 232b. The coordinate points described above are the points at which the tag pattern 230 overlaps with the line L of the pattern 210. Finally, the tag pattern 230 and the pattern 210 combined to obtain a pattern 240, wherein a line segment 240a overlapping with the line segment L corresponds to the line segment 230a of the tag pattern 230. The coordinates of the two terminals of the line segment 230a corresponding to the coordinate of the line segment 240a line segment L comprises, the coordinate 241a corresponding to the coordinate 231a and coordinate 242a corresponding to coordinate 232a respectively. Likewise, line segment 240b of the line segment L is the line segment 230b of the tag pattern 230, and the coordinates of two terminals of the line segment has the corresponding coordinates as described above.

Additionally, in the representing method according to an embodiment of the present invention, the tag code may also be converted by using a plurality of points. FIG. 2B is a schematic illustration of a method of converting a tag with a number of points according to one embodiment of the present invention. Referring to FIG. 2B, when the content of the tag 220 of the pattern 210 illustrated in FIG. 2A is, for example, “A2”, the “A2” is converted into a tag code, which is represented by, for example, a plurality of points. The tag code may be converted into a tag pattern 230 composed of, for example, a plurality of points. For example, the content “A” in the tag code 220 may be represented by a plurality of points 250a, and the content “2” of the tag code 220 may be, for example, represented by three points 250b, 251b and 252b. Furthermore, each point of the converted tag code has a coordinate point, wherein the coordinate point is a corresponding point at which the tag pattern 250 overlaps with the line L in the pattern 210. Finally, the tag pattern 250 and the pattern 210 may be combined to obtain a pattern 260, wherein the point 260a of the line segment L of the pattern 260 corresponds to the point 250a of the tag pattern 250, and the points 260b, 261b and 262b of the line segment L of the pattern 260 correspond to the points 250b, 251b and 252b of the tag pattern 250.

Moreover, in a representing method according to another embodiment of the present invention, the tag may also be transformed into a plurality of segments with intervals there-between. FIG. 2C is a schematic illustration of a method of transforming a tag having at least an interval between line segments according to one embodiment of the present invention. Referring to FIG. 2C, when the content of the tag 220 of the pattern 210 illustrated in FIG. 2A is, for example, “A2”, the “A2” is transformed into a tag code including, for example, at least an interval between a plurality of line segments. The tag 220 may be converted into a tag pattern 270 composed of, for example, interval(s) between a plurality of line segments. For example, the content “A” of the tag 220 may be represented by an interval 270a between the line segments L1 and L2, and the content “2” of the tag 220 may be represented by an interval 270a between the line segments L2 and L3. Furthermore, each of the two terminals of the interval between the line segments of the tag pattern 270 has a coordinate point that corresponds point of the tag pattern 270 overlapping with the line L of the pattern 210. Finally, the tag pattern 270 and the pattern 210 may be combined to obtain a pattern 280 including an interval 280a between two line segments in the line segment L of the pattern 280 corresponding to the interval 270a between the line segments of the tag pattern 270. In addition, the interval 280b between two line segments in the line segment L of the pattern 280 corresponds to the interval 270b between the line segments of the tag pattern 270.

FIG. 3 is a flowchart illustrating a tag reading method according to one embodiment of the present invention. Referring to FIG. 3, at step S310, a pattern including a tag pattern is selected, wherein the pattern represents a pattern includes a tag pattern obtained via a code conversion operation. Thereafter, at step S320, at least a repeated point in the pattern has to be determined. Then, at step S330, the content represented by the point is determined according to a predetermined principle. The determining method according to the predetermined principle for the repeated point comprises, for example, identifying the repeated number of points, the repeated point formed by the length of the line segment or the repeated point formed by the interval(s) between a plurality of line segments. Thereafter, at step S340, the pattern including tag pattern is transformed into a tag, which is not being coded.

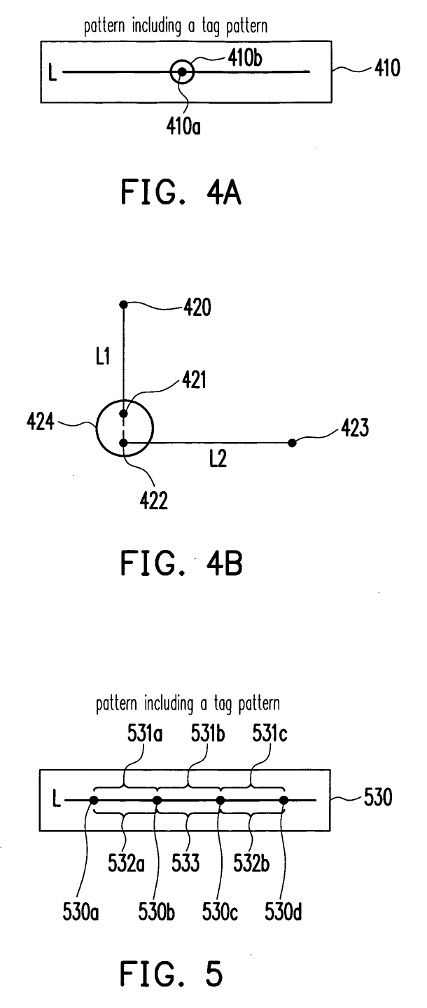

At step S330 described above, after at least one repeated point in the pattern is identified, a predetermined principle is adopted for determining the content of the repeat point, for example, the repeated number of points are determined to determine the content of the tag. FIG. 4A is a schematic view illustrating the method of determining the content of point by determining the repeated number of points according to one embodiment of the present invention. Referring to FIG. 4A, the pattern combined with tag pattern 410 comprises a line L. Thereafter, at least a repeated point of the pattern of line L is identified, and thus two repeated points of the figure of the line L, for example, the points 410a and 410b that longitudinally and mutually overlapped are identified respectively. Then, the number of repeated points may be used as a predetermined parameter to determine the content of the point to decode the tag.

In one embodiment of the present invention, the relationship of the longitudinally overlapped points 410a and 410b may be determined by a variety of methods. For example, when two terminal points of a line segment are used in the database storing the figure file, the point at the corner is a repeated point consequentially. Therefore, the point at the corner may not be used as the point for code conversion. As shown in FIG. 4B, in the database, if the points 420 and 421 are used for representing the line segment L1, the points 422 and 423 are used for representing the line segment L2, and if the points 421 and point 422 are located at the same position represented by the point 424, the point 424 may not be used as the point for converting the tag pattern. In another embodiment of the present invention, the point 424 may be used as a point for converting the tag pattern, however, the determination of the points may be complicated.

In one embodiment of the present invention, when continuous points are used to represent a line segment in the database comprising the pattern file, for example, the sequential points 420, 421 and 423 are used to represent the L-shaped line segment, the position 424 of the point 421 may be used as a point for converting tag pattern.

FIG. 5 is a schematic view illustrating the method of determining the content of the tag by determining the repeated number of points according to another embodiment of the present invention. Referring to FIG. 5, the pattern combined with tag pattern 530 comprises a line L. Thereafter, four repeated points of the pattern comprising line L are identified, for example, points 530a, 530b, 530c and 530d respectively. Since the four points described above are located in the same line L, the four points 530a, 530b, 530c and 530d may be regarded as repeated points. Then, the number of the repeated points may be used as a predetermined parameter to determine content of the point to decode the tag code.

In addition, the intervals between any two of the four point described above may also be used as a standard of the predetermined parameter to obtain the content. For example, in FIG. 5, the interval 531a between the points 530a and 530b, the interval 531b between the point 530b and 530c, and the interval 531c between the points 530c and 530d may be used to determine the content of the tag.

Moreover, the interval between any two line segments (wherein each line segment is composed by two repeated points) may also be used as a standard of a predetermined parameter to obtain a content of the code. For example, in FIG. 5, the interval between the line segment 532a composed of the points 530a and 530b and the line segment 532b composed of the point 530c and 530d may be used to determine the content of the repeated pattern.

Accordingly, in the tag writing and reading method of the present invention, a code conversion process is provided for the tag writing method. For example, a length of line segment, a number of points, or the interval(s) between a plurality of line segments may be used to represent the code. Thereafter, the coded tag pattern is combined with the pattern of the integrated circuit (IC). In addition, in the tag reading method, a predetermined parameter comprising, for example, repeated number of points, repeated point extending by the length of line segment length, or repeated point formed by the interval(s) between a plurality of line segments are provided for determining the content of the tag. The tag writing and reading method of the present invention is more rigorous and safer than the conventional pattern or label used as an identification tag. In addition, the content of the tag can not be readily tampered or smeared. Therefore, the coded tag pattern combined with the IC may include more information and may ensure the completeness of the tag.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A tag writing method, suitable for a semiconductor product, comprising:
providing a code for representing a tag;
converting the code into a tag pattern, wherein the tag pattern is combined with a portion of a pattern of the semiconductor product; and
using the combined pattern including the pattern of the semiconductor product and the tag pattern as a design content of the semiconductor product.

2. The tag writing method of claim 1, wherein a length of a line segment is provided for representing the code.

3. The tag writing method of claim 1, wherein a number of a plurality of points is provided for representing the code.

4. The tag writing method of claim 1, wherein at least an interval between a plurality of line segments is provided for representing the code.

5. The tag writing method of claim 1, wherein the tag comprises a patent number.

6. A tag reading method, suitable for reading a pattern of a semiconductor product, wherein the pattern comprises a tag pattern overlapped with a portion of an original pattern of the semiconductor product, the reading method comprising:
reading an original file representing the pattern;
identifying at least a repeated portion of the original file repeated with the pattern; and
determining a content represented by the repeated portion according to a predetermined parameter.

7. The tag reading method of claim 6, wherein the predetermined principle comprises a plurality of repeated points.

8. The tag reading method of claim 6, wherein the predetermined parameter comprises a length of a line segment formed by a plurality of points that is repeated.

9. The tag reading method of claim 6, wherein the predetermined parameter comprises at least an interval between a plurality of line segments formed by a plurality of points that is repeated.
